(19) United States
(12) Patent Application Publication
(10) Pub. No.: US 2025/0303534 A1
(43) Pub. Date: Oct. 2, 2025

(54) Hand-Held Power Tool

(71) Applicant: Robert Bosch GmbH, Stuttgart (DE)

(72) Inventors: Tobias Herr, Grafenau (DE); Cornelius Hartmann, Moensheim (DE); Heiko Roehm, Stuttgart (DE); Jens Blum, Filderstadt (DE); Marcus Schuller, Dettenhausen (DE); Rainer Britz, Schorndorf (DE)

(21) Appl. No.: 19/085,745

(22) Filed: Mar. 20, 2025

(30) Foreign Application Priority Data
Mar. 26, 2024 (DE) 10 2024 202 880.0

(51) Int. Cl. B25B 23/14; B23B 45/00; B25B 21/02; B25B 23/147; B25F 5/00

(52) U.S. Cl. CPC B25B 23/1415; B25B 21/02; B25B 23/1475; B25F 5/001; B23B 45/008

(57) ABSTRACT

A hand-held power tool has a housing, a drive motor including a drive shaft, a transmission drivable by the drive shaft, and a tool holder for holding an insertion tool, which is drivable by the transmission. The transmission includes a transmission housing, a transmission cover, and a fixed ring gear. The transmission cover at least partially closes the transmission housing. The fixed ring gear is located such that the fixed ring gear has a breakaway torque.

This application claims priority under 35 U.S.C. § 119 to application no. DE 10 2024 202 880.0, filed on Mar. 26, 2024 in Germany, the disclosure of which is incorporated herein by reference in its entirety.

The present disclosure relates to a hand-held power tool.

### BACKGROUND

A hand-held power tool with a drive motor, with a transmission and a transmission cover is already disclosed in DE 10 2017 211 774 A1.

### SUMMARY

The present disclosure proceeds from a hand-held power tool with a housing, with a drive motor that comprises a drive shaft, with a transmission that is drivable by means of the drive shaft, wherein the transmission comprises a transmission housing a transmission cover and a fixed ring gear, wherein the transmission cover at least partially closes the transmission housing, and with a tool holder for holding an insertion tool, wherein the tool holder is drivable by means of the transmission. It is proposed that the fixed ring gear be arranged such that the fixed ring gear has a breakaway torque.

The disclosure provides a hand-held power tool with a slip clutch, in which the fixed ring gear is arranged such that the fixed ring gear comprises breakaway torque. The slip clutch allows a blocking transmission to be substantially prevented. When operating the hand-held power tool, operating conditions may occur, in which the transmission is blocked. However, the drive motor continues to rotate such that the transmission and/or tool holder would receive damage in the blocked operating state. To avoid this, the slip clutch is proposed where the fixed ring gear has breakaway torque,

which is less than or equal to the maximum torque. The slip clutch may be located and/or configured between the fixed ring gear and the transmission cover and/or between the fixed ring gear and the transmission housing.

The hand-held power tool can be configured as an electrically operated hand-held power tool. The electrically operated hand-held power tool can be configured as a plug-in or a cordless hand-held power tool. For example, the hand-held power tool can be designed as a screwdriver, a drill screwdriver, a rotary impact screwdriver, a hammer, a drill hammer or an impact drill screwdriver.

The housing of the hand-held power tool is configured to at least partly accommodate the drive motor, the transmission and the tool holder. The housing can be configured as a shell housing with two half shells.

The hand-held power tool comprises the tool holder. The tool holder can be configured as an internal tool holder, for example a bit holder, and/or as an external tool holder, for example a socket holder. It is also conceivable that the tool holder is configured as a drill chuck. The tool holder can accommodate insertion tools, such as screwdriver bits or sockets, so that a user can produce screw connections between a fastening element and a fastening holder.

The hand-held power tool has a drive unit. The drive unit comprises the drive motor and the transmission. The drive motor can be an electrically commutated motor. In particular, the drive motor can be designed as at least one electric motor. The transmission comprises the transmission housing, the transmission cover, and the fixed ring gear. The transmission can be configured as at least one planetary gear, wherein it can, for example, be shiftable. The planetary gear can comprise at least one planetary carrier and planetary gears. The fixed ring gear may be located on the transmission cover. The fixed ring gear is a ring gear that is stationary in at least one state. The fixed ring gear may be associated with a first and/or second gear stage of the transmission. The fixed ring gear may be located in the direction of the drive motor. In the case of a shiftable transmission, it is possible to switch between at least two gear stages by means of at least one gear shifting element, in particular a gear shifter. The drive motor is configured such that it can be actuated via a manual switch. When the manual switch is actuated by a user, the drive motor is switched on and the hand-held power tool is put into operation. If the manual switch is not further actuated by the user, the drive motor is switched off. The drive motor can preferably be electronically controlled and/or regulated in such a way that a reversing mode and a specification for a desired rotational speed can be implemented. In reversing mode, the drive motor can be switched between a clockwise direction of rotation and a counterclockwise direction of rotation. To switch the drive motor in reversing mode, the hand-held power tool can comprise a rotation direction switching element, in particular a rotation direction changeover switch.

The hand-held power tool can comprise a percussion mechanism. The percussion mechanism generates high torque peaks during operation to loosen tight connecting means or to fasten connecting means or to drill holes. The percussion mechanism can be connected to the drive motor by means of the transmission. The percussion mechanism can, for example, be designed as a rotational percussion mechanism, a detent percussion mechanism, a rotary percussion mechanism, a V-groove percussion mechanism or a hammer percussion mechanism. The transmission and/or the percussion mechanism can have an intermediate shaft. For example, the intermediate shaft can accommodate the planetary gears of the transmission. Furthermore, the intermediate shaft can at least partially actuate the percussion mechanism. The percussion mechanism may comprise a percussion mechanism housing and/or a percussion mechanism cover. Furthermore, the percussion mechanism may include at least one striker and at least one percussion mechanism spring. The striker and the percussion mechanism spring can be located substantially within the percussion mechanism housing. The percussion mechanism spring can, for instance, be configured as a spiral spring, a barrel-shaped spring, a conical spring, a chimney spring or a profiled spring. The percussion mechanism cover, particularly in the axial direction, can be positioned between the percussion mechanism, specifically the striker and the percussion mechanism spring, and the drive motor. It is conceivable that the percussion mechanism cover and the transmission housing are made as a single piece. It is also conceivable that the percussion mechanism cover and the transmission cover are made as a single piece.

The drive motor comprises the drive shaft. The drive shaft is mounted in the housing via at least one drive shaft bearing. The drive motor can actuate the transmission, the percussion mechanism and/or the tool holder by means of the drive shaft. The drive shaft bearing can be configured as a ball bearing, a rolling bearing or a sliding bearing, for example. The drive shaft bearing can be located at an end of the drive motor facing the tool holder. The drive shaft bearing can be located, in particular in the axial direction, between the transmission and the drive motor. The drive shaft can project into the intermediate shaft. The drive shaft bearing can be located in the intermediate shaft so that the drive shaft is mounted in the intermediate shaft via the drive shaft bearing. A further drive shaft bearing can also be provided to support the drive shaft. The further drive shaft bearing can be located at the end of the drive motor facing away from the tool holder. The further drive shaft bearing can be configured as a ball bearing, a rolling bearing or a sliding bearing, for example. The hand-held power tool can have a tool axis. In this case, an axis of rotation of the drive shaft can form the tool axis. “Axial” is in particular intended to be understood as substantially parallel to the tool axis. Whereas “radial” is intended to be understood as substantially perpendicular to the tool axis.

The transmission comprises the transmission cover that at least partially closes the transmission. The transmission cover can be located axially between the percussion mechanism tool and the drive motor. Furthermore, the transmission cover can be located axially between the at least one planetary gear stage and the drive motor. The transmission cover can accommodate the fixed ring gear of the transmission, in particular the planetary gear. For example, the transmission cover may be designed in the form of a pot, a bowl, a lid, or a disc.

In one embodiment, the fixed ring gear and the transmission cover are made as one piece. In this case, the transmission cover forms the fixed ring gear such that they are one piece.

In one embodiment, the fixed ring gear and the transmission housing are made as one piece. Thus, the transmission housing forms the fixed ring gear such that they are one piece.

In one embodiment, the fixed ring gear abuts the transmission cover and/or the transmission housing. Thus, the fixed ring gear may directly and immediately abut the transmission cover and/or the transmission housing.

In one embodiment, the fixed ring gear comprises at least one plug-in element and the transmission, in particular the transmission cover and/or the transmission housing, comprises at least one plug-in element receptacle, wherein the plug-in element receptacle is configured to receive the plug-in element. The plug-in element may be formed radially and/or axially on the fixed ring gear. It is conceivable that the plug-in element may be connected to the fixed ring gear in an interlocking, force-fitting, and/or bonding manner. It is possible that the plug-in element may be one piece with the fixed ring gear. For example, the plug-in element can be configured in the manner of a bar, a protrusion, partially circumferential, in a crown-like or ring-like manner. For example, more than one plug-in element may be formed, such as two, three, four or more than four plug-in elements. The plug-in element receptacle may be configured to be complementary to the plug-in element. The transmission cover can be connected to the plug-in element receptacle in an interlocking, force-fitting, or bonded manner. In addition, the plug-in element receptacle may be made in one piece with the transmission cover. For example, the plug-in element receptacle may be configured as a recess, a protrusion, an indentation, a groove, or a partially circumferential groove. By means of the plug-in element and the plug-in element receptacle, the fixed ring gear can then be inserted into the transmission, in particular the transmission cover and/or the transmission housing. It is also possible for the transmission housing to form the plug-in element and for the fixed ring gear to form the plug-in element receptacle.

The hand-held power tool may comprise a torque coupling. The torque coupling can be configured to be adjustable, wherein the user can adjust desired torques by means of an adjustment ring. The torque coupling is configured to trigger when the desired torque is achieved. The torque coupling can be located axially between the tool holder and the transmission.

The hand-held power tool further includes a power supply, wherein the power supply is provided for cordless operation by means of rechargeable batteries, in particular hand-held power tool rechargeable battery packs, and/or for plug-in operation. In a preferred embodiment, the power supply is configured for cordless operation. In the context of the present disclosure, a “hand-held power tool rechargeable battery pack” is intended to be understood as a combination of at least one battery cell and a rechargeable battery pack housing. The hand-held power tool rechargeable battery pack is advantageously configured for supplying power to commonly available cordless hand-held power tools. The at least one battery cell can, for instance, be configured as a Li-ion battery cell having a nominal voltage of 3.6 V. The hand-held power tool rechargeable battery pack can include up to ten battery cells, for example, although a different number of battery cells is conceivable too. Both an embodiment as a cordless hand-held power tool and operation as a plug-in hand-held power tool are sufficiently well-known to those skilled in the art, so the specifics of the power supply will not be discussed here.

The hand-held power tool can have a control unit at least for controlling the drive unit. The control unit can be located in the housing, for example in a handle of the hand-held power tool or in a region of a power supply interface.

In one embodiment of the hand-held power tool, the breakaway torque of the fixed ring gear is less than or equal to a maximum torque. The fixed ring gear is arranged such that the breakaway torque of the fixed ring gear is less than or equal to the maximum torque, particularly of the hand-held power tool, reduced by a gear ratio. The fixed ring gear may be mounted such that the breakaway torque may be less than or equal to 80% of the maximum torque. It is conceivable that the breakaway torque of the fixed ring gear may be adjustable. Furthermore, it is conceivable that the fixed ring gear will break away at a torque value less than 80% of the maximum torque. The breakaway torque is the torque, at which the fixed ring gear becomes at least partially movable. Thus, the fixed ring gear can move at least partially once the breakaway torque has been reached. For example, the maximum torque may consist of a flywheel mass of the armature shaft, a flywheel mass of the intermediate shaft, and/or a flywheel mass of the planets of the planetary gear. It is also conceivable that the maximum torque may be set on a fixed ring gear support. The maximum torque may then be the output torque of the hand-held power tool reduced by a gear ratio.

In one embodiment of the hand-held power tool, the fixed ring gear is at least partially rotatable relative to the drive motor, particularly a stator of the drive motor. The fixed ring gear may then rotate at least partially relative to the drive motor, particularly the stator of the drive motor, to counteract the blocked operating state. The drive motor further comprises a stator and a rotor. The stator is fixed in the housing. The rotor can be connected to the drive shaft. In addition, the rotor may have rotor magnets.

In one embodiment of the hand-held power tool, the fixed ring gear is configured to be at least partially rotatable relative to the transmission housing. The fixed ring gear may then rotate at least partially relative to the transmission housing, to counteract the blocked operating state.

In one embodiment, the fixed ring gear is configured to be at least partially rotatable relative to the transmission cover. The fixed ring gear may then rotate at least partially relative to the transmission cover, to counteract the blocked operating state.

In one embodiment, the hand-held power tool includes at least one locking element configured to at least partially engage with at least one detent element of the fixed ring gear. The fixed ring gear comprises the detent element. The detent element can be connected to the fixed ring gear in an interlocking, form-fitting and/or bonding manner. It is conceivable that the detent element is one piece with the fixed ring gear. The locking element is configured to at least partially engage the detent element and at least partially secure the fixed ring gear. The locking element can be configured such that when the breakaway torque is exceeded, the locking element releases the fixed ring gear. The fixed ring gear can then move at least partially, in particular rotate at least partially. For example, one, two, or more than two locking elements may be configured. At least two of the locking elements can be located opposite one another. The locking element can be designed as leaf spring or a sphere with a coil spring, for example. The locking element can be located between the housing and the fixed ring gear. The locking element can be located radially between the fixed ring gear and the housing, for example. Furthermore, the locking element can be located axially between the fixed ring gear and the housing. The fixed ring gear comprises the detent element. The detent element and the fixed ring gear can be connected in an interlocking, form-fitting and/or bonding manner. It is possible that the fixed ring gear and the detent element are made as one piece. The detent element can, for example, be formed as indentations, in the manner of a crown gear, in the form of a ring, or in a gear-shaped manner.

In one embodiment, the detent element is formed radially on the fixed ring gear. The detent element is configured radially to the tool axis or to the drive shaft on the fixed ring gear. The detent element can be configured according to a type of sprocket, for example. The locking element can be located radially between the fixed ring gear and the housing. The locking element can be configured as a leaf spring, for example.

In one embodiment, the detent element is axially formed on the fixed ring gear. The detent element is configured axially to the tool axis or to the drive shaft on the fixed ring gear. The detent element can be configured according to a type of crown gear, for example. The locking element may be located axially between the fixed ring gear and the housing or drive motor. For example, the locking element can be configured as a single, or a plurality of, leaf spring(s) or as a single, or a plurality of, sphere(s) with coil springs, wherein the number of the spheres and the coil springs can be the same.

In one embodiment, the hand-held power tool includes at least one biasing element configured to at least partially bias the fixed ring gear. The biasing element is configured to bias the fixed ring gear such that the breakaway torque is adjustable. For example, the breakaway torque may be adjusted using different types and/or material compositions of the biasing element. In addition, the biasing element is configured to bias the fixed ring gear such that upon reaching the breakaway torque, the fixed ring gear is at least partially movable, in particular at least partially rotatable.

In one embodiment of the hand-held power tool, the biasing element is configured as at least one spring element, such as a leaf spring, a coil spring, a viscoelastic element, or a viscoelastic ring, and/or as at least one sealing element. The spring element can be ring-shaped or polygonal, for example. For example, the sealing element can be ring-shaped or polygonal. For example, the breakaway torque may be adjusted by different spring rates, elasticity modules, diameters, surface conditions, and/or coefficients of static friction of the biasing element.

In one embodiment of the hand-held power tool, the biasing element is located between the transmission cover and the transmission housing. The biasing element may be located axially to the tool axis or drive shaft between the transmission cover and the transmission housing. In addition, the biasing element may also be located radially to the tool axis or to the drive shaft between the transmission cover and the transmission housing. The biasing element may bias the transmission cover relative to the transmission housing. The biasing element may abut the transmission cover and the transmission housing. As a result, the biasing element may also act as a seal between the transmission cover and the transmission housing.

In one embodiment of the hand-held power tool, the biasing element is located between the transmission cover and the housing. The biasing element may be located radially to the tool axis or drive shaft between the transmission cover and the housing. Furthermore, the biasing element may be located axially to the tool axis or to the drive shaft between the transmission cover and the housing. For this purpose, the transmission cover may include a receptacle for the biasing element. The receptacle for the biasing element can, for example, be configured as a groove or an annular groove, in particular at least partially circumferentially. In addition, the receptacle for the biasing element may be formed radially and/or axially on the transmission cover.

In one embodiment of the hand-held power tool, the biasing element is located between the fixed ring gear and the transmission housing. The biasing element may be located radially to the tool axis or to the drive shaft between the fixed ring gear and the transmission housing. In addition, the biasing element may be located axially to the tool axis or to the drive shaft between the fixed ring gear and the transmission housing. For this purpose, the fixed ring gear and/or the transmission housing may each have a receptacle that is formed radially and/or axially on the fixed ring gear and/or the transmission housing.

In one embodiment of the hand-held power tool, the biasing element is located between the fixed ring gear and the transmission cover. The biasing element may be located radially to the tool axis or to the drive shaft between the fixed ring gear and the transmission cover. In addition, the biasing element may be located axially to the tool axis or to the drive shaft between the fixed ring gear and the transmission housing. For this purpose, the fixed ring gear and/or the transmission cover may each have a receptacle that is formed axially and/or radially on the fixed ring gear and/or transmission cover.

In one embodiment of the hand-held power tool, the biasing element is located between the fixed ring gear and the housing. The biasing element may be located radially to the tool axis or to the drive shaft between the fixed ring gear and the housing. Furthermore, the biasing element may be located axially to the tool axis or to the drive shaft between the fixed ring gear and the housing. For this purpose, the fixed ring gear and/or the transmission cover may each have a receptacle that can be formed axially and/or radially on the fixed ring gear and/or the transmission cover.

In one embodiment, one of the biasing elements is located between the transmission cover and the fixed ring gear and one of the biasing elements is located between the fixed ring gear and the transmission housing. In this case, at least two of the biasing elements are provided. One of the biasing elements is then located axially to the tool axis or to the drive shaft between the transmission cover and the fixed ring gear, and one of the biasing elements is located axially to the tool axis or to the drive shaft between the fixed ring gear and the transmission housing.

The transmission and/or the percussion mechanism may comprise the slip clutch. The slip clutch may comprise at least the fixed ring gear, the locking element, and/or the biasing element. The slip clutch is designed to direct the fixed ring gear such that upon reaching the breakaway torque, the fixed ring gear is at least partially movable, in particular at least partially rotatable.

### BRIEF DESCRIPTION OF THE DRAWINGS

The disclosure is explained below with reference to preferred embodiments. The drawings show:

FIG. 1 a schematic view of a hand-held power tool according to the disclosure;

FIG. 2 a section of a longitudinal cross-section of the hand-held power tool;

FIG. 3 a section of a front view of a first embodiment of a fastening element and a detent element;

FIG. 4 the section with a second embodiment of the fastening element and the detent element in a perspective view;

FIG. 5a the section with a third embodiment of the fastening element and the detent element in a perspective view;

FIG. 5b a lower section with the third embodiment of the fastening element and the detent element in a longitudinal cross-section;

FIG. 6 an upper section of a longitudinal cross-section with a first embodiment of a biasing element;

FIG. 7 the upper section of the longitudinal cross-section with a second embodiment of the biasing element;

FIG. 8a the upper section of the longitudinal cross-section with a third embodiment of the biasing element;

FIG. 8b the upper section of the longitudinal cross-section with a fourth embodiment of the biasing element;

FIG. 9a the upper section of the longitudinal cross-section with a fifth embodiment of the biasing element;

FIG. 9b the upper section of the longitudinal cross-section with a sixth embodiment of the biasing element;

FIG. 9c the upper section of the longitudinal cross-section with a seventh embodiment of the biasing element;

FIG. 9d the upper section of the longitudinal cross-section with an eighth embodiment of the biasing element;

FIG. 10a the upper section of the longitudinal cross-section with a ninth embodiment of the biasing element;

FIG. 10b the upper section of the longitudinal cross-section with a tenth embodiment of the biasing element; and

FIG. 10c the upper section of the longitudinal cross-section with an eleventh embodiment of the biasing element.

### DETAILED DESCRIPTION

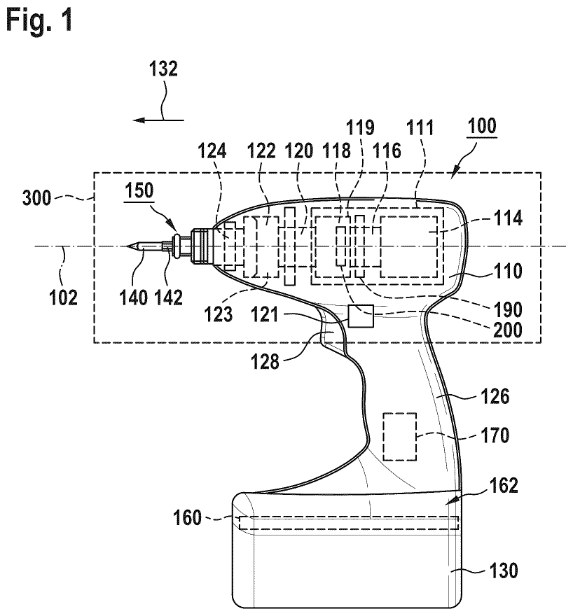

FIG. 1 shows a hand-held power tool 100 according to the disclosure, which is configured as a cordless rotary impact screwdriver 100, for example. The hand-held power tool 100 comprises an output shaft 124 and a tool holder 150. The hand-held power tool 100 comprises a housing 110 with a handle 126. To provide a power supply that is independent of the electric grid, the hand-held power tool 100 can be mechanically and electrically connected to a power supply for cordless operation, so that the hand-held power tool 100 is configured as a cordless hand-held power tool 100. A hand-held power tool rechargeable battery pack 130 is used here as the power supply. The present disclosure is not limited to cordless hand-held power tools, however, but can also be used for those dependent on the electric grid, i.e. plug-in hand-held power tools.

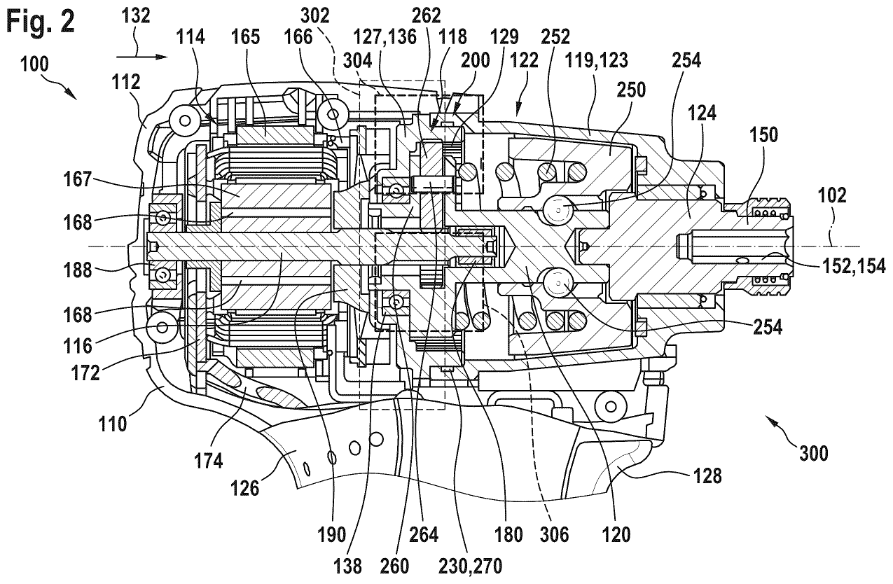

The housing 110 comprises a drive unit 111. The drive unit 111 is located in the housing 110. The drive unit 111 comprises an electrically commutated drive motor 114, which is supplied with power by the hand-held power tool rechargeable battery pack 130, and a transmission 118. The drive motor 114 comprises a stator 165, motor terminals 166, a rotor 167 and rotor magnets 168; see also FIG. 2. The transmission 118 is designed as at least one planetary gear. The drive motor 114 is designed such that it can be actuated, for example via a manual switch 128, so that the drive motor 114 can be switched on and off. The drive motor 114 can advantageously be electronically controlled and/or regulated, so that a reversing mode and a desired rotational speed can be implemented. For the reversing mode, the hand-held power tool 100 comprises a rotation direction switching element 121 configured as a rotation direction changeover switch. The rotation direction switching element 121 is configured to switch the drive motor 114 between a clockwise direction of rotation and a counterclockwise direction of rotation. The design and mode of operation of a suitable drive motor are sufficiently well-known to those skilled in the art, which is why they will not be discussed in more detail here.

The housing 110 at least partially accommodates the drive motor 114, the transmission 118 and the tool holder 150. The housing 110 is formed here as a shell housing with two half shells 112.

The transmission 118 is connected to the drive motor 114 via a drive shaft 116. The drive shaft 116 is mounted in the housing 110 by means of a drive shaft bearing 180 and a further drive shaft bearing 188; see also FIG. 2. The transmission 118 is intended to convert a rotation of the drive shaft 116 into a rotation between the transmission 118 and the tool holder 150. The transmission 118 comprises a transmission housing 119, a transmission cover 136, and a fixed ring gear 129, wherein the transmission cover 136 at least partially closes the transmission housing 119. The fixed ring gear 129 is located such that the breakaway torque of the fixed ring gear 129 is less than or equal to the maximum torque, particularly of the hand-held power tool 100. Thus, the hand-held power tool 100 comprise a slip clutch 200 that counteracts blocking operating states of at least the transmission 118 by means of the fixed ring gear 129; see also FIGS. 2-10.

The hand-held power tool 100 configured as a cordless rotary impact screwdriver comprises a rotary percussion mechanism 122 with an intermediate shaft 120; see also FIG. 2. Both the rotary percussion mechanism 122 and the intermediate shaft 120 are located within the housing 110. Preferably, the conversion from rotation of the drive shaft 116 to rotation of the tool holder 150 occurs via the intermediate shaft 120. This conversion takes place such that the intermediate shaft 120 rotates relative to the drive shaft 116 with increased torque, but at a reduced rotational speed. In this case, the drive shaft 116 protrudes into the intermediate shaft 120, for example; see FIG. 2. By way of example, the drive shaft bearing 180 is substantially located in the intermediate shaft 120 such that the drive shaft 116 is substantially supported in the intermediate shaft 120 by means of the drive shaft bearing 180. The rotary percussion mechanism 122 comprises a percussion mechanism housing 123, wherein the rotary percussion mechanism 122 can also be located in another suitable housing, such as the transmission housing 119. The rotary percussion mechanism 122 is configured to drive the output shaft 124. The rotary percussion mechanism 122 includes a percussion mechanism cover 127 that closes off the rotary percussion mechanism 122 in the direction of the drive motor 114. For example, the percussion mechanism cover 127 and the transmission cover 136 are made as one piece. In addition, the transmission housing 119 and the percussion mechanism housing 123 are made as one piece, for example. The transmission 118 and/or the rotary percussion mechanism 122 comprise the slip clutch 200. The slip clutch 200 is located and/or formed between the fixed ring gear 129 and the transmission cover 136 and/or between the fixed ring gear 129 and the transmission housing 119.

Furthermore, the hand-held power tool 100 comprises a fan impeller 190. The fan impeller 190 is intended to generate an air flow in the housing 110. The hand-held power tool 100 comprises a tool axis 102, wherein here an axis of rotation of the drive shaft 116 forms the tool axis 102.

The tool holder 150 is provided on the output shaft 124. The tool holder 150 is preferably molded onto and/or designed on the output shaft 124. The tool holder 150 is preferably located in an axial direction 132 with respect to the drive unit 111. The tool holder 150 is configured here as a hexagon socket, in the form of a bit holder, which is provided to accommodate an insertion tool 140. The insertion tool is configured in the form of a screwdriver bit with a polygonal external coupling 142. The type of the screwdriver bit, for example HEX type, is sufficiently well-known to those skilled in the art. The present disclosure is not limited to the use of HEX screwdriver bits, however; other tool holders that appear useful to the those skilled in the art, such as HEX drills, SDS quick-insertion tools, sockets or round-shank drill chucks, can be used as well. The design and functioning of a suitable bit holder are sufficiently well-known to those skilled in the art as well.

The hand-held power tool 100 comprises a control unit 170 at least for controlling the drive unit 111, in particular the drive motor 114, and a sensor board 172 for sensor-controlled commutation of the electrically commutated drive motor 114; see FIG. 2. The sensor board 172 is located in the housing 110 between the drive motor 114 and the further drive shaft bearing 188. The housing 110 at least partly accommodates the control unit 170. The sensor board 172 is connected to the control unit 170 by means of a sensor cable 174 for sensor-controlled commutation of the drive motor 114; see also FIG. 2. The control unit 170 comprises a not further depicted microprocessor. The sensor board 172 comprises three sensor elements not shown in detail, which are designed as Hall sensors, for example.

The housing 110 also comprises a power supply holding device 160. The power supply holding device 160 accommodates the hand-held power tool rechargeable battery pack 130 and forms a base 162 comprising a standing surface. The hand-held power tool rechargeable battery pack 130 can be released from the power supply holding device 160 without tools. The housing 110 also comprises the handle 126 and the power supply holding device 160. The handle 126 can be grasped by the user. In one embodiment, the power supply holding device 160 is located on the handle 126. The hand-held power tool 100 can be set down on the base 162.

FIG. 2 shows a section 300 of a longitudinal cross-section of the hand-held power tool 100. The rotary percussion mechanism 122 includes a striker 250 and a percussion mechanism spring 252. The striker 250 is mounted on the intermediate shaft 120 by means of percussion mechanism ball bearings 254. The percussion mechanism ball bearings 254 are provided to move the striker 250 at least partly in the direction of the drive motor 114. The intermediate shaft 120 is supported by an intermediate shaft bearing 138. The intermediate shaft bearing 138 is located substantially in the transmission cover 136, as an example. The intermediate shaft bearing 138 is located radially between the intermediate shaft 120 and the transmission cover 136. The intermediate shaft bearing 138 is configured as a ball bearing, for example. In addition to the fixed ring gear 129, the transmission 118 includes a planet carrier 260, planet gears 262, and bearing bolts 264, wherein only one planet gear 262 and one bearing bolt 264 are shown here. The bearing bolts 264 are designed to rotatably arrange the planet gears 262 in the planet carrier 260. The planet gears 262 engage in the fixed ring gear 129. The fixed ring gear 129 is at least partially rotatable relative to the drive motor 114, particularly the stator 165 of the drive motor 114. Furthermore, the fixed ring gear 129 is designed to be at least partially rotatable relative to the transmission housing 119. The fixed ring gear 129 abuts the transmission housing 119 here. The hand-held power tool 100 includes at least one biasing element 230, 231, 232, 233, 234, 235, 236, 237, 238, 239, 240, 241, 270 that is designed to at least partially bias the fixed ring gear 129. Here, the biasing element 230 is configured as at least one sealing element 270. The sealing element 270 is located radially, in particular to the tool axis 102, between the fixed ring gear 129 or the transmission cover 136 and the transmission housing 119 or the percussion mechanism housing 123, respectively.

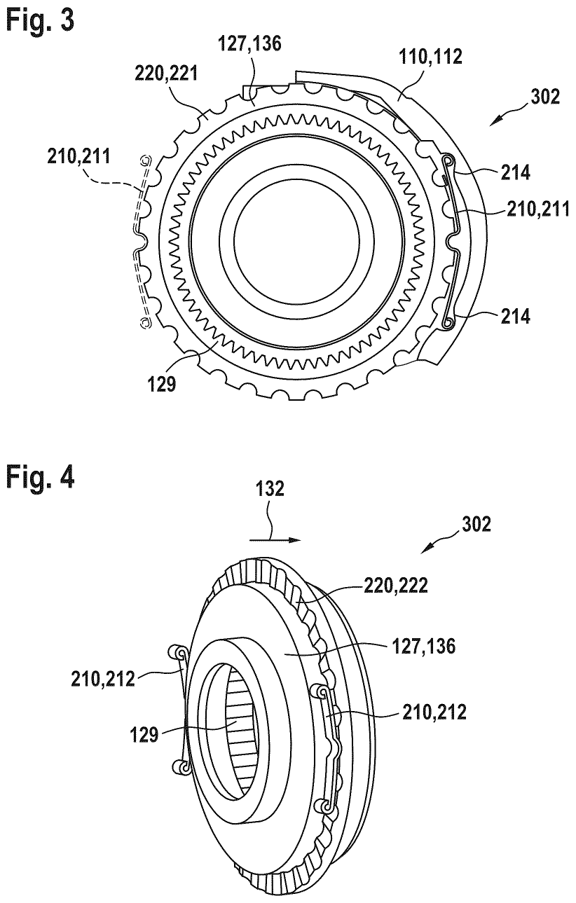

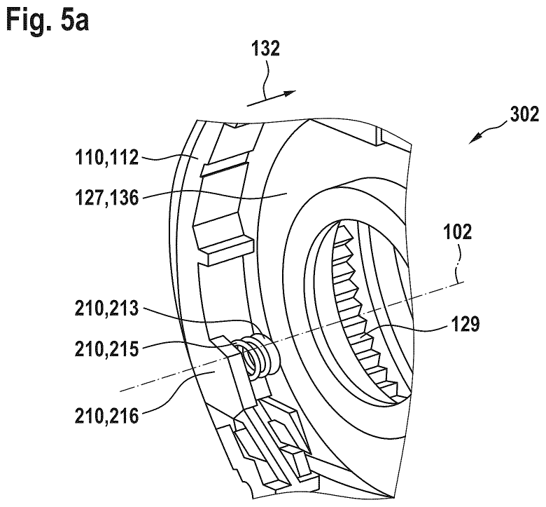

FIG. 3 shows a section 302 of a front view of a first embodiment of a locking element 210, 211 and a detent element 220, 221. The front view is shown such that the fixed ring gear 129 is shown from a direction of the tool holder 150 towards the drive motor 114. Here, the fixed ring gear 129 and the transmission cover 136 are made as one piece. The hand-held power tool 100 includes the locking element 210; see also FIG. 4. The locking element 210 is designed to at least partially engage at least the detent element 220 of the fixed ring gear 129. The detent element 220, 221 is made as one piece with the fixed ring gear 129 here. The transmission cover 136 is then made as one piece with the detent element 220. For example, two locking elements 210 are formed, which are located opposite to one another, particularly radially. For example, the locking element 210 can be formed as a leaf spring 211. The locking elements 210, 211 are located radially between the housing 110 and the fixed ring gear 129. The detent element 220 is, for example, configured in the form of a gear 221. The detent element 220, 221 is formed radially to the tool axis 102 on the fixed ring gear 129 or on the transmission cover 136. The housing 110 comprises at least one receptacle 214 for the locking element 210, 211. The receptacle 214 is designed to at least partially receive each of the locking elements 210, 211 and position them relative to the detent element 220, 221.

FIG. 4 shows the section 302 of a second embodiment of the locking element 210, 212 and the detent element 220, 222 in a perspective view. For example, the fixed ring gear 129 and the transmission cover 136 are made as one piece. The detent element 220, 222 is made as one piece with the fixed ring gear 129. Two locking elements 210, 212 are formed as leaf springs 212. The locking elements 210, 212 in the second embodiment are located radially opposite to each other. Furthermore, the locking elements 210, 212 are located axially between the housing 110 and the fixed ring gear 129. The fixed ring gear 129 and the detent element 220, 222 are made as one piece, so that the transmission cover 136 also comprises the detent element 220, 222. The detent element 220 is formed here as a crown gear 222, for example. The detent element 220, 222 is formed axially to the tool axis 102 on the fixed ring gear 129 or on the transmission cover 136.

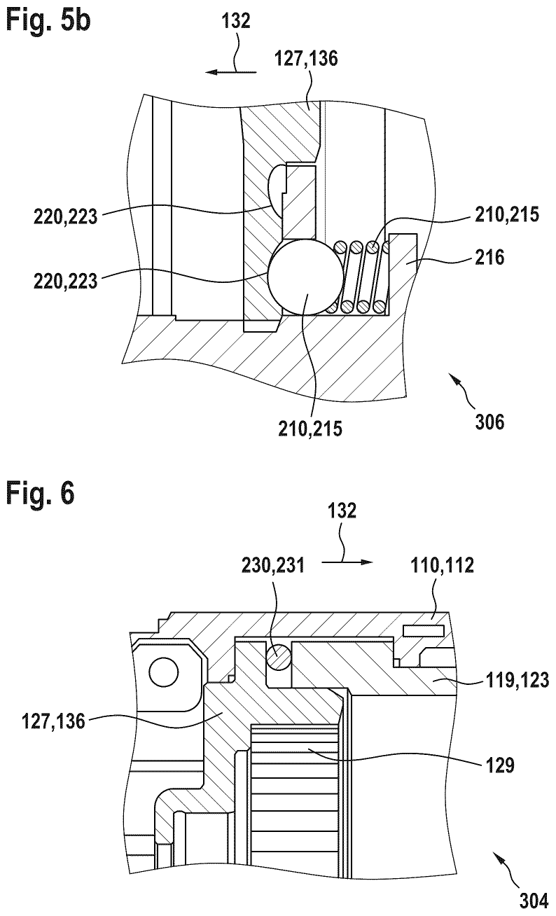

FIG. 5a shows the section 302 with a third embodiment of the locking element 210, 213 and the detent element 220, 223 in a rear perspective view. For example, the fixed ring gear 127 and the transmission cover 136 are made as one piece. The fixed ring gear 129 includes the detent element 220, 223, which are made as one piece, so that the transmission cover 136 and the detent element 220, 223 are also made as one piece. For example, two locking elements 210, 213, 215 are formed, wherein only one of the locking elements 210, 213, 215 are shown. The locking element 210 is formed as a ball 213 with a coil spring 215, wherein they are located axially between the housing 110 and the fixed ring gear 129, for example. For this purpose, the housing 110 has a receptacle 216 for the locking element 210, 213, 215, on which the locking element 210, 213, 215 rests. The detent element 220 is formed as a ring 223 and is formed axially towards the drive motor 114 on the fixed ring gear 129, for example. FIG. 5b shows a lower section 306 with the third embodiment of the locking element 210, 213, 215 and the detent element 220, 223 in a longitudinal cross-section. The lower section 306 is below the tool axis 102 and radially between the tool axis 102 and the manual switch 128.

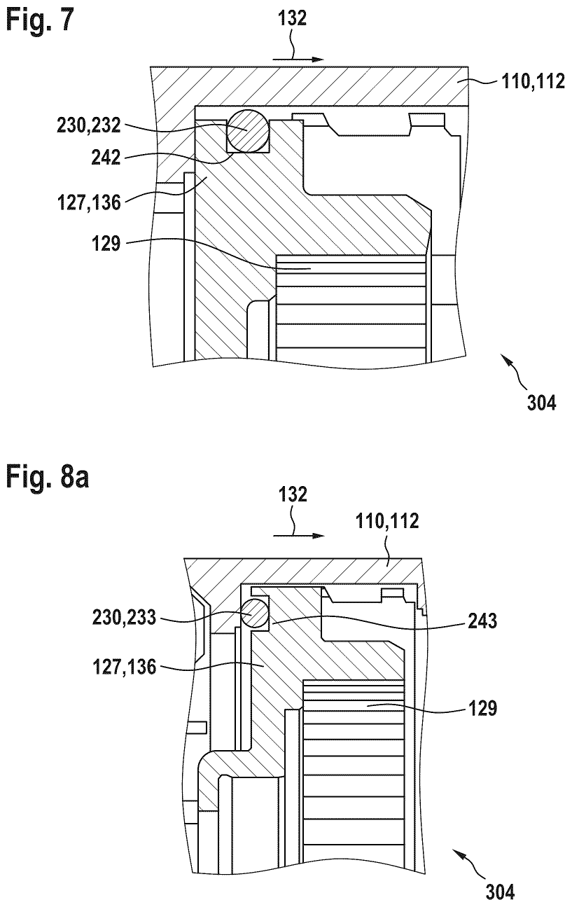

FIG. 6 shows an upper section 304 of a longitudinal cross-section with a first embodiment of the biasing element 230, 231 as a spring element 231, 232, 233, 234, 235, 236, 237, 238, 239, 240, 241. The biasing element 230 is shown in the first embodiment 231. The upper section 304 is above the tool axis 102, wherein the tool axis 102 is located radially between the lower section 306 and the upper section 304. The fixed ring gear 129 and the transmission cover 136 are made as one piece. The handheld power tool 100 includes the biasing element 230. The biasing element 230 is designed to bias the fixed ring gear 129. The biasing element 230 is formed as a spring element. Here, the biasing element 230 is formed as a viscoelastic ring 231. The biasing element 230, 231 is located axially between the transmission cover 136 and the transmission housing 119.

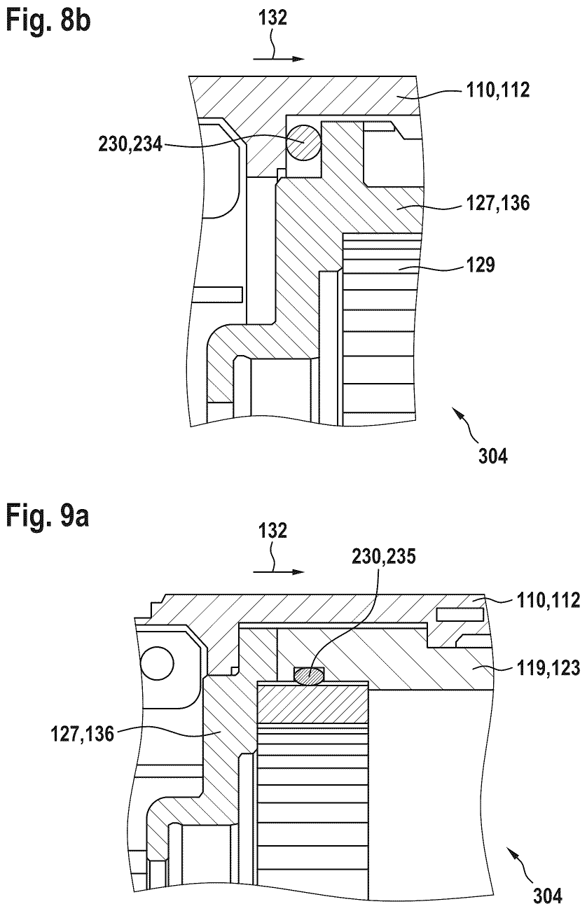

FIG. 7 shows the upper section 304 of the longitudinal cross-section with a second embodiment of the biasing element 230, 232 as the spring element. For example, the fixed ring gear 129 and the transmission cover 136 are made as one piece. In the second embodiment, the biasing element 230 is formed as a viscoelastic ring 232 located radially between the transmission cover 136 and the housing 110. The transmission cover 136 includes a receptacle 242 for the biasing element 230, 232, wherein the receptacle 242 for the biasing element 230, 232 is configured as a ring groove, for example. The receptacle 242 for the biasing element 230, 232 is formed radially and circumferentially on the transmission cover 136.

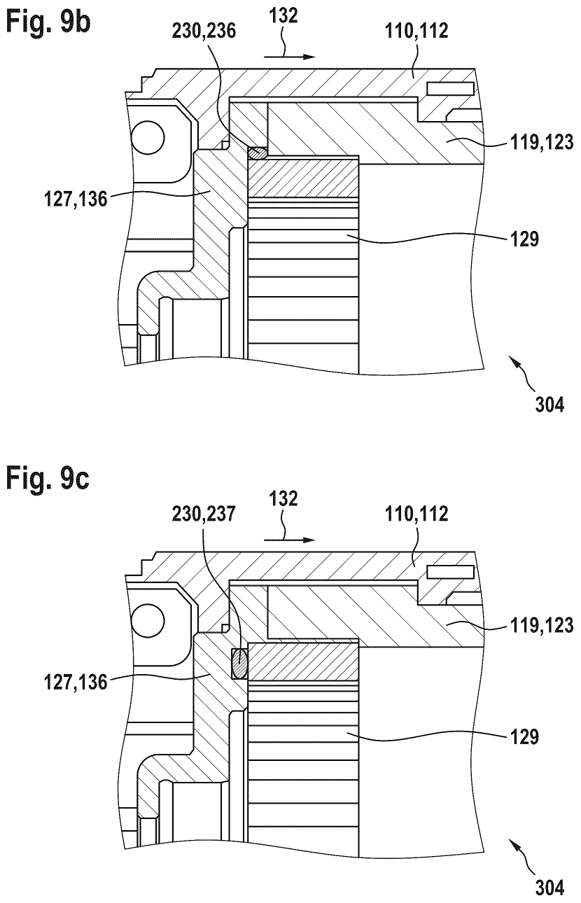

FIG. 8a shows the upper section 304 of the longitudinal cross-section with a third embodiment of the biasing element 230, 233 as the spring element. FIG. 8b shows the upper section 304 of the longitudinal cross-section with a fourth embodiment of the biasing element 230, 234 as the spring element. In both FIG. 8a and FIG. 8b, the fixed ring gear 129 and the transmission cover 136 are made as one piece. In the third embodiment, the biasing element 230 is formed as a viscoelastic ring 233. In the fourth embodiment, the biasing element 230 is also configured as a viscoelastic ring 234. The biasing element 230 in the third and fourth embodiments 233, 234 is located between the transmission cover 136 and the housing 110, particularly axially to the tool axis 102. In FIG. 8a, the transmission cover 136 includes a receptacle 243 for the biasing element 230 in the third embodiment 233. The receptacle 243 for the biasing element 230 in the third embodiment 233 is formed as a ring groove. The receptacle 243 for the biasing element 230, 233 receives the biasing element 230 circumferentially in the third embodiment 233. The receptacle 243 for the biasing element 230, 233 is formed radially to the tool axis 102 between the fixed ring gear 129 and the housing 110 and is configured circumferentially. In FIG. 8b, in the fourth embodiment 234, the biasing element 230 abuts the transmission cover 136 circumferentially relative to the tool axis 102.

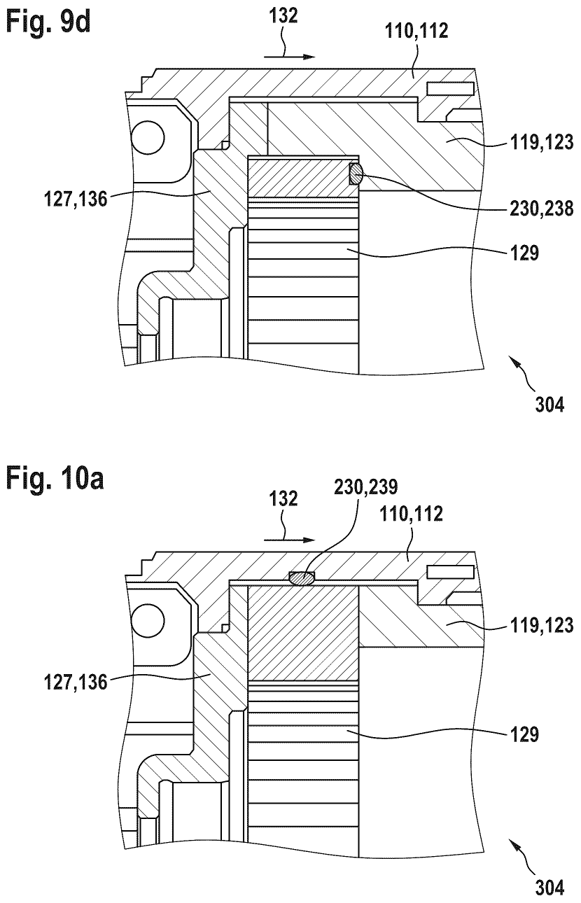

FIGS. 9a-9d show the upper section 304 of the longitudinal cross-section with a fifth, sixth, seventh, and eighth embodiment of the biasing element 230, 235, 236, 237, 238 as the spring element. In FIGS. 9a to 9d, the transmission cover 136, the fixed ring gear 129, and the transmission housing 119 are separate components and may each abut one another. FIG. 9a shows the fifth embodiment 235 of the biasing element 230. The fifth embodiment of the biasing element 230 is configured as a viscoelastic ring 235. In the fifth embodiment 235 of the biasing element 230, the biasing element 230, 235 is located radially, particularly to the tool axis 102, between the fixed ring gear 129 and the transmission housing 119. FIG. 9b shows the sixth embodiment 236 of the biasing element 230, which is formed as a viscoelastic ring 236. The sixth embodiment 236 of the biasing element 230 is located radially, particularly to the tool axis 102, between the fixed ring gear 129 and the transmission cover 136. FIG. 9c shows the seventh embodiment 237 of the biasing element 230. The seventh embodiment of the biasing element 230 is formed as a viscoelastic ring 237. The seventh embodiment 237 of the biasing element 230 is located axially, particularly to the tool axis 102, between the fixed ring gear 129 and the transmission cover 136. FIG. 9d shows the eighth embodiment 238 of the biasing element 230. The eighth embodiment of the biasing element 230 is configured as a viscoelastic ring 238. The eighth embodiment 238 of the biasing element 230 is located axially, particularly to the tool axis 102, between the fixed ring gear 129 and the transmission housing 119.

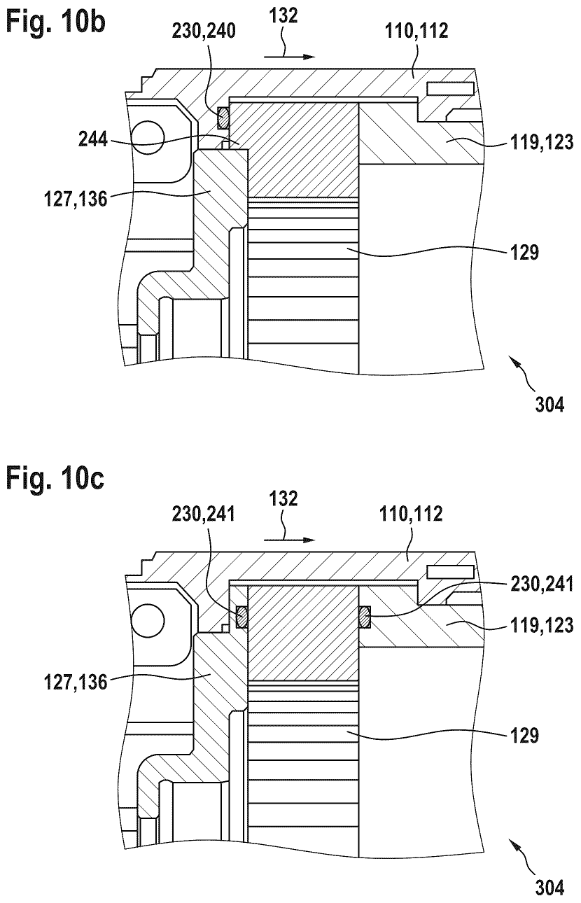

FIGS. 10a to 10c each show the upper section 304 of the longitudinal cross-section with a ninth, tenth, and eleventh embodiment 239, 240, 241 of the biasing element 230 as the spring element. In FIGS. 10a, 10b, and 10c, the transmission cover 136, the fixed ring gear 129, and the transmission housing 119 are separate components located axially in relation to each other. In FIG. 10a and FIG. 10b, the fixed ring gear 129 abuts the transmission cover 136 and the transmission housing 119. The fixed ring gear 129 is at least partially rotatably formed in FIG. 10a and FIG. 10b relative to the transmission cover 136. In FIG. 10a, the ninth embodiment 239 of the biasing element 230 is shown, wherein the ninth embodiment of the biasing element 230 is formed as a viscoelastic ring 239. In the ninth embodiment 239 of the biasing element 230, the biasing element 230, 239 is located radially, particularly to the tool axis 102, between the fixed ring gear 129 and the housing 110. In FIG. 10b, the tenth embodiment 240 of the biasing element 230 is illustrated, which is formed as a viscoelastic ring 240. The tenth embodiment 240 of the biasing element 230 is located axially, particularly in to the tool axis 102, between the fixed ring gear 129 and the housing 110. Here, the fixed ring gear 129 has a circumferential protrusion 244, as an example. The tenth embodiment 240 of the biasing element 230 abuts the circumferential protrusion 244. In FIG. 10c, the eleventh embodiment 241 of the biasing element 230 is shown. The eleventh embodiment of the biasing element 230 is formed as two viscoelastic rings 241. In the eleventh embodiment 241 of the biasing element 230, one of the biasing elements 230, 241 is located axially, particularly to the tool axis 102, between the transmission cover 136 and the fixed ring gear 129, and one of the biasing elements 230, 241 is located axially, particularly to the tool axis 102, between the fixed ring gear 129 and the transmission housing 119.

1. A hand-held power tool comprising:
a housing;
a drive motor comprising a drive shaft;
a transmission driven by the drive shaft, the transmission comprising:
a transmission housing;
a transmission cover at least partially closing the transmission housing; and
a fixed ring gear; and
a tool holder configured to hold an insertion tool, the tool holder being driven by the transmission,
wherein the fixed ring gear is arranged such that the fixed ring gear has a breakaway torque.

2. The hand-held power tool according to claim 1, wherein the breakaway torque of the fixed ring gear is less than or equal to a maximum torque.

3. The hand-held power tool according to claim 1, wherein the fixed ring gear is at least partially rotatable relative to the drive motor.

4. The hand-held power tool according to claim 1, wherein the fixed ring gear is at least partially rotatable relative to a stator of the drive motor.

5. The hand-held power tool according to claim 1, wherein the fixed ring gear is at least partially rotatable relative to the transmission housing.

6. The hand-held power tool according to claim 1, further comprising at least one locking element configured to at least partially engage with at least one detent element of the fixed ring gear.

7. The hand-held power tool according to claim 1, further comprising at least one biasing element configured to at least partially bias the fixed ring gear.

8. The hand-held power tool according to claim 7, wherein the at least one biasing element includes at least one spring element and/or at least one sealing element.

9. The hand-held power tool according to claim 7, wherein the at least one biasing element is located between the transmission cover and the transmission housing.

10. The hand-held power tool according to claim 7, wherein the at least one biasing element is located between the transmission cover and the housing.

11. The hand-held power tool according to claim 7, wherein the at least one biasing element is located between the fixed ring gear and the transmission housing.

12. The hand-held power tool according to claim 7, wherein the at least one biasing element is located between the fixed ring gear and the transmission cover.

13. The hand-held power tool according to claim 7, wherein the at least one biasing element is located between the fixed ring gear and the housing.
